(19) United States
(12) Patent Application Publication
(10) Pub. No.: US 2022/0361099 A1
(43) Pub. Date: Nov. 10, 2022

(54) Enhancements On Thermal Throttling Design For A Multi-Radio Transmitter

(71) Applicant: MEDIATEK INC., Hsinchu City (TW)

(72) Inventors: Tsai-Yuan HSU, Hsinchu City (TW); Yu-Hsien CHANG, Hsinchu City (TW); Chin-Hung WANG, Hsinchu City (TW)

(21) Appl. No.: 17/732,669

(22) Filed: Apr. 29, 2022

Related U.S. Application Data
(60) Provisional application No. 63/183,676, filed on May 4, 2021.

(51) Int. Cl. H04W 52/02; H04W 52/36

(52) U.S. Cl. CPC H04W 52/0206; H04W 52/36; H04W 88/10

(57) ABSTRACT

A transmitter including two radio transceivers and a controller is provided. The first radio transceiver supports a first number of Spatial Streams (SS) for a first Transmission (Tx) opportunity of wireless transmission to a receiver. The second radio transceiver supports a second number of SS for a second Tx opportunity of wireless transmission to the receiver. The first Tx opportunity starts earlier than the second Tx opportunity. The controller determines whether the power consumption of SS utilization in the first and second Tx opportunities exceeds a threshold, and if so, performs one of the following: deferring the second Tx opportunity until the first Tx opportunity ends; and aborting the first Tx opportunity when the second Tx opportunity starts.

### CROSS REFERENCE TO RELATED APPLICATIONS

This application claims priority under 35 U.S.C. § 119 from U.S. Provisional Application No. 63/183,676, entitled “Smart RF transmission throttling among multi-radios”, filed on May 4, 2021, the subject matter of which is incorporated herein by reference.

### BACKGROUND OF THE APPLICATION

### Field of the Application

The application generally relates to wireless communications and, more particularly, to enhancements on the thermal throttling design for a multi-radio transmitter.

### Description of the Related Art

With growing demand for ubiquitous computing and networking, various wireless technologies have been developed, including Wireless-Fidelity (Wi-Fi) which is a Wireless Local Area Network (WLAN) technology allowing mobile devices, such as a smartphone, a smart pad, a laptop computer, a portable multimedia player, an embedded apparatus, or the like, to obtain wireless services in a frequency band of 2.4 GHz, 5 GHz, and/or 60 GHz.

The Institute of Electrical and Electronics Engineers (IEEE) 802.11 has commercialized or developed various technological standards since an initial WLAN technology is supported using frequencies of 2.4 GHz. For example, IEEE 802.11n supports Multiple Input-Multiple-Output (MIMO) which is a technique for multiplying the capacity of a radio link using multiple transmission and receiving antennas to form multiple Spatial Streams (SS) to exploit multipath propagation. Later in IEEE 802.11ac, Multi-User (MU) transmission is supported, which uses spatial degrees of freedom via a MU-MIMO scheme in a downlink (DL) direction from an Access Point (AP) to Stations (STAs). To improve the performance experienced by users of the aforementioned mobile devices, who demand high-capacity and high-rate services, the Dual Band Dual Concurrent (DBDC) technology is developed which enables two unique data streams to run at full throughput simultaneously in both 2.4 GHz and 5 GHz frequency bands.

However, it is observed that most wireless communication devices supporting DBDC may have a problem of overheating when the number of SS and supported radios increases. The thermal risk becomes even worse in small-sized products.

### BRIEF SUMMARY OF THE APPLICATION

To reduce the thermal risk, conventional practices generally apply a thermal throttling design which monitors the thermal change of a DBDC-enabled product and degrades the product's MIMO capability when overheating is detected. Consequently, data throughput will be decreased, causing bad user experience.

In order to alleviate the burden of data throughput impact while reducing the thermal risk, the present application proposes enhancements on the thermal throttling design for a multi-radio transmitter. Specifically, the enhancements may include any combination of the following: (1) a mechanism to limit the number of Tx streams and power level among multi-radios below the boundary of thermal throttle power based on per-packet control; (2) a mechanism to defer Tx opportunity of one radio when the minimum of Tx power consumption, contributed by stream number and power level, is more than the left available power headroom; and (3) a mechanism to abort the existing Tx opportunity which priority is lower than the incoming Tx opportunity to guarantee power consumption below the thermal limit.

In one embodiment of the application, a transmitter comprising two radio transceivers and a controller is provided. The first radio transceiver supports a first number of Spatial Streams (SS) for a first Transmission (Tx) opportunity of wireless transmission to a receiver. The second radio transceiver supports a second number of SS for a second Tx opportunity of wireless transmission to the receiver, wherein the first Tx opportunity starts earlier than the second Tx opportunity. The controller is configured to determine whether power consumption of SS utilization in the first and second Tx opportunities exceeds a threshold, and in response to the power consumption of SS utilization in the first and second opportunities exceeding the threshold, perform one of the following: deferring the second Tx opportunity until the first Tx opportunity ends; and aborting the first Tx opportunity when the second Tx opportunity starts.

In another embodiment of the application, a method is provided. The method comprises the following steps: providing, by a transmitter, a first radio transceiver supporting a first number of SS for a first Tx opportunity of wireless transmission to a receiver; providing, by the transmitter, a second radio transceiver supporting a second number of SS for a second Tx opportunity of wireless transmission to the receiver, wherein the first Tx opportunity starts earlier than the second Tx opportunity; determining, by the transmitter, whether power consumption of SS utilization in the first and second Tx opportunities exceeds a threshold; and in response to the power consumption of SS utilization in the first and second opportunities exceeding the threshold, performing, by the transmitter, one of the following: deferring the second Tx opportunity until the first Tx opportunity ends; and aborting the first Tx opportunity when the second Tx opportunity starts.

In one example, the method further comprises: reducing, by the transmitter, the first number of SS for the first Tx opportunity or the second number of SS for the second Tx opportunity, in response to the power consumption of SS utilization in the first and second opportunities exceeding the threshold. The reduced first number of SS or the reduced second number of SS may comprise at least one SS.

In one example, the method further comprises: before the second Tx opportunity starts, determining, by the transmitter, a power headroom below the threshold; wherein the deferring of the second Tx opportunity is performed in response to the power headroom not sufficing for a power consumption of utilizing only one SS in the second Tx opportunity.

In one example, the aborting of the first Tx opportunity is performed in response to data traffic in the first Tx opportunity having a lower priority than data traffic in the second Tx opportunity.

In one example, the threshold is configured for thermal throttling of the controller.

In one example, the transmitter is a Wireless-Fidelity (Wi-Fi) Station (STA) operating in a non-Access Point (AP) mode, and the receiver is a Wi-Fi AP.

In one example, the transmitter is a Wi-Fi STA operating in an AP mode, and the receiver is a Wi-Fi STA.

In one example, the transmitter is a Wi-Fi AP, and the receiver is a Wi-Fi STA.

In one example, the first Tx opportunity is a first time duration for which the first radio transceiver is allowed to perform wireless transmission, and the second Tx opportunity is a second time duration for which the second radio transceiver is allowed to perform wireless transmission.

Other aspects and features of the present application will become apparent to those with ordinarily skill in the art upon review of the following descriptions of specific embodiments of the apparatuses and methods of enhancements on the thermal throttling design for a multi-radio transmitter.

### BRIEF DESCRIPTION OF THE DRAWINGS

The present application can be more fully understood by reading the subsequent detailed description and examples with references made to the accompanying drawings, wherein:

FIG. 1 is a block diagram of a wireless communication system according to an embodiment of the application;

FIG. 2 is a block diagram illustrating 2×2 MIMO operations;

FIG. 3 is a block diagram illustrating 4×4 MIMO operations;

FIG. 4 is a block diagram illustrating a transmitter according to an embodiment of the application;

FIG. 5 is a schematic diagram illustrating the enhanced thermal throttling design for a multi-radio transmitter according to an embodiment of the application;

FIG. 6 is a schematic diagram illustrating the enhanced thermal throttling design for a multi-radio transmitter according to another embodiment of the application; and

FIG. 7 is a flow chart illustrating the method of enhancements on the thermal throttling design for a multi-radio transmitter according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises”, “comprising”, “includes”, and/or “including” when used herein, specify the presence of stated features, integers, steps, operations, elements, and/or components, but do not preclude the presence or addition of one or more other features, integers, steps, operations, elements, components, and/or groups thereof.

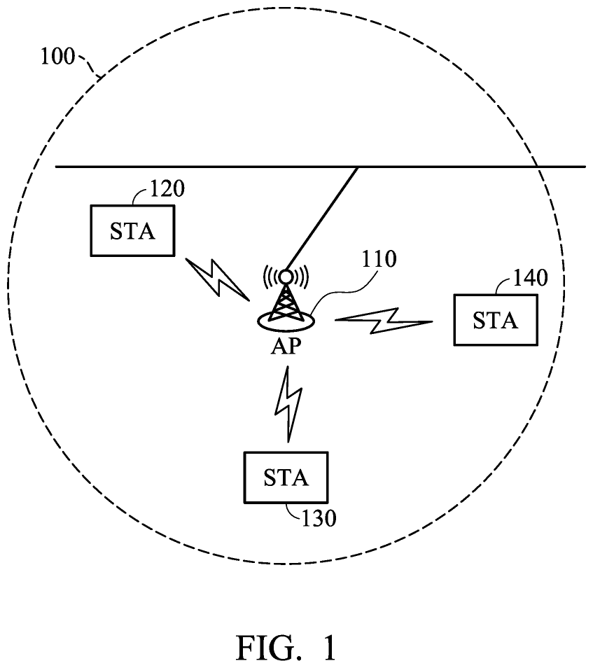

FIG. 1 is a block diagram of a wireless communication system according to an embodiment of the application.

As shown in FIG. 1, the wireless communication system 100 includes an Access Point (AP) 110 and a plurality of stations (STAs) 120˜140. The AP 110 is an entity compatible with IEEE 802.11 standards to provide and manage the access to the wireless medium for the STAs 120˜140.

In one embodiment, the AP 110 may be an AP or a STA operating in the AP mode, which supports MIMO and DBDC.

Each of the STAs 120˜140 may be a mobile phone (e.g., feature phone or smartphone), a panel Personal Computer (PC), a laptop computer, or any wireless communication terminal, as long as it is compatible with the same IEEE 802.11 standard as the AP 110. Each of the STAs 120˜140 may operate in the non-AP mode to associate and communicate with the AP 110 for transmitting and/or receiving data.

For example, in downlink (DL) direction, the AP 110 may be referred to as a transmitter which transmits data to either one of the STAs 120˜140 (or referred to as a receiver) using a plurality of antennas for MIMO operations. Similarly, in uplink (UL) direction, any one of the STAs 120˜140 may be referred to as a transmitter which transmits data to the AP 110 (or referred to as a receiver) using a plurality of antennas for MIMO operations. The number of antennas used in MIMO operations depends on the capabilities and configurations of the AP 110 and the STAs 120˜140.

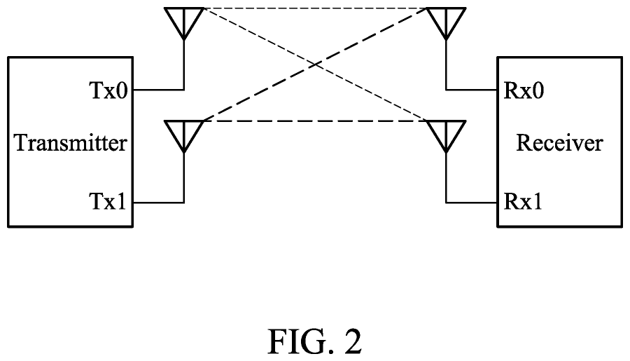

FIG. 2 is a block diagram illustrating 2×2 MIMO operations.

As shown in FIG. 2, 2×2 MIMO (or called 2T2R) operations involve the use of two antennas in both the transmitter and the receiver to establish up to two streams of data therebetween. Compared to ordinary single antenna (SISO) operations, 2×2 MIMO operations may offer up to a 100% increase in data throughput. With two spatial streams (SS) established, the data payload is divided across both antennas and transmitted over the same frequency band. In order for spatial multiplexing to be effective, the antennas should be well isolated and configured to provide a low correlation coefficient.

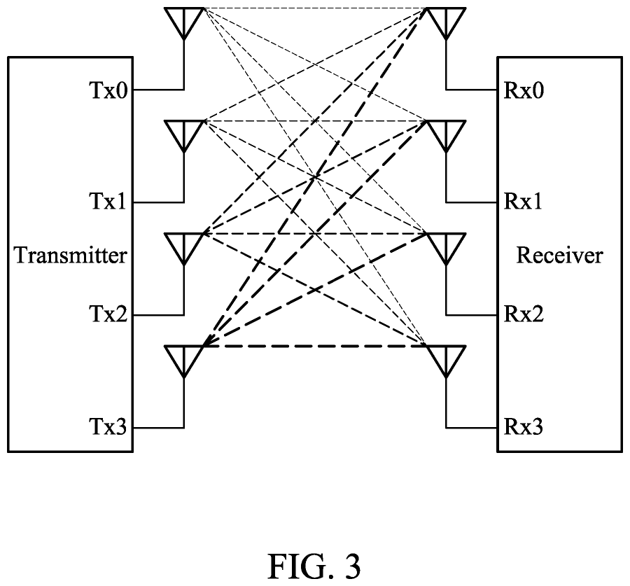

FIG. 3 is a block diagram illustrating 4×4 MIMO operations.

As shown in FIG. 3, 4×4 MIMO (or called 4T4R) operations involve the use of four antennas in both the transmitter and the receiver to establish up to four streams therebetween. Compared to ordinary single antenna (SISO) operations, 4×4 MIMO operations may offer up to a 400% increase in data throughput. With four SS established, the data payload is divided across all four antennas and transmitted over the same frequency band.

In accordance with one novel aspect of the present application, enhancements on the thermal throttling design for a multi-radio transmitter are proposed. Specifically, the enhancements may include any combination of the following: (1) a mechanism to limit the number of Tx streams and power level among multi-radios below the boundary of thermal throttle power based on per-packet control; (2) a mechanism to defer Tx opportunity of one radio when the minimum of Tx power consumption, contributed by stream number and power level, is more than the left available power headroom; and (3) a mechanism to abort the existing Tx opportunity which priority is lower than the incoming Tx opportunity to guarantee power consumption below the thermal limit.

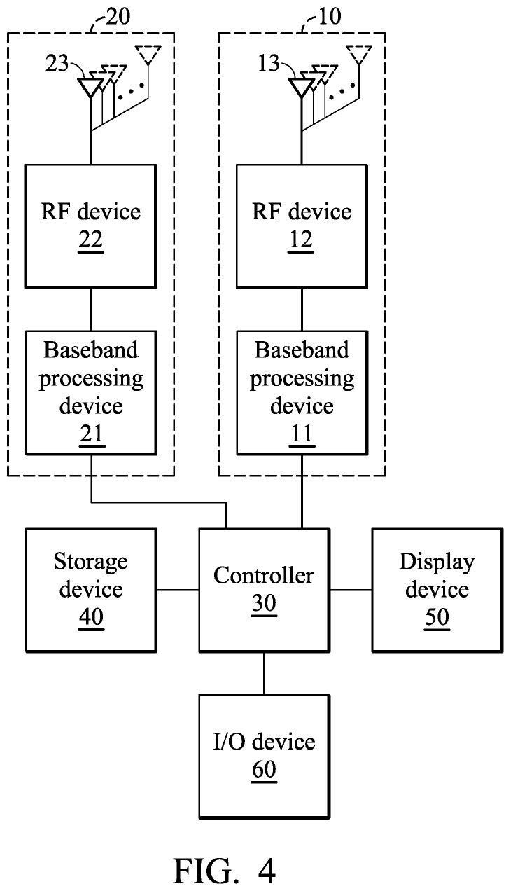

FIG. 4 is a block diagram illustrating a transmitter according to an embodiment of the application.

As shown in FIG. 4, a transmitter (e.g., an STA or AP) may include two radio transceivers 10 and 20, a controller 30, a storage device 40, a display device 50, and an Input/Output (I/O) device 60.

The radio transceivers 10 and 20 are configured to perform wireless transceiving to and from a receiver (e.g., an STA or AP), and each of the radio transceivers 10 and 20 supports one or more SS.

The radio transceiver 10 may include a baseband processing device 11, a Radio Frequency (RF) device 12, and one or more antennas 13.

The baseband processing device 11 is configured to perform baseband signal processing. The baseband processing device 11 may contain multiple hardware components, such as a baseband processor, to perform the baseband signal processing, such as Analog-to-Digital Conversion (ADC)/Digital-to-Analog Conversion (DAC), gain adjusting, modulation/demodulation, encoding/decoding, and so on.

The RF device 12 may receive RF wireless signals via the antennas 13, convert the received RF wireless signals to baseband signals, which are processed by the baseband processing device 11, or receive baseband signals from the baseband processing device 11 and convert the received baseband signals to RF wireless signals, which are later transmitted via the antennas 13. The RF device 12 may also contain multiple hardware devices to perform radio frequency conversion. For example, the RF device 12 may include a mixer to multiply the baseband signals with a carrier oscillated in the radio frequency of the supported Wi-Fi technology, wherein the radio frequency may be 2.4 GHz, 5 GHz, or 60 GHz, or any radio frequency utilized in the future evolution of the Wi-Fi technology.

Similarly, the radio transceiver 20 may include a baseband processing device 21, an RF device 22, and one or more antennas 23.

The baseband processing device 21 is configured to perform baseband signal processing. The baseband processing device 21 may contain multiple hardware components, such as a baseband processor, to perform the baseband signal processing, such as ADC/DAC, gain adjusting, modulation/demodulation, encoding/decoding, and so on.

The RF device 22 may receive RF wireless signals via the antennas 23, convert the received RF wireless signals to baseband signals, which are processed by the baseband processing device 21, or receive baseband signals from the baseband processing device 21 and convert the received baseband signals to RF wireless signals, which are later transmitted via the antennas 23. The RF device 22 may also contain multiple hardware devices to perform radio frequency conversion. For example, the RF device 22 may include a mixer to multiply the baseband signals with a carrier oscillated in the radio frequency of the supported Wi-Fi technology, wherein the radio frequency may be 2.4 GHz, 5 GHz, or 60 GHz, or any radio frequency utilized in the future evolution of the Wi-Fi technology.

In another embodiment, the radio transceivers 10 and 20 may be incorporated into a single chip (or called combo chip).

The controller 30 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the radio transceivers 10 and 20 for wireless communications with the receiver, storing and retrieving data (e.g., program code) to and from the storage device 40, sending a series of frame data (e.g. representing text messages, graphics, images, etc.) to the display device 50, and receiving user inputs or outputting signals via the I/O device 60.

In particular, the controller 30 coordinates the aforementioned operations of the radio transceivers 10 and 20, the storage device 40, the display device 50, and the I/O device 60 for performing the method of the present application.

In another embodiment, the controller 30 may be incorporated into the baseband processing device 11 or the baseband processing device 21, to serve as a baseband processor.

As will be appreciated by persons skilled in the art, the circuits of the controller 30 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 40 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 50 may be a Liquid-Crystal Display (LCD), a Light-Emitting Diode (LED) display, an Organic LED (OLED) display, or an Electronic Paper Display (EPD), etc., for providing a display function. Alternatively, the display device 50 may further include one or more touch sensors for sensing touches, contacts, or approximations of objects, such as fingers or styluses.

The I/O device 60 may include one or more buttons, a keyboard, a mouse, a touch pad, a video camera, a microphone, and/or a speaker, etc., to serve as the Man-Machine Interface (MI) for interaction with users.

It should be understood that the components described in the embodiment of FIG. 4 are for illustrative purposes only and are not intended to limit the scope of the application. For example, if the transmitter is an STA, such as a smartphone, it may include more components, such as a Global Positioning System (GPS) device for use of some location-based services or applications, and/or a battery for powering the other components of the transmitter, etc. Alternatively, if the transmitter is an AP, it may include fewer components. For example, the transmitter may not include the display device 50 and/or the I/O device 60.

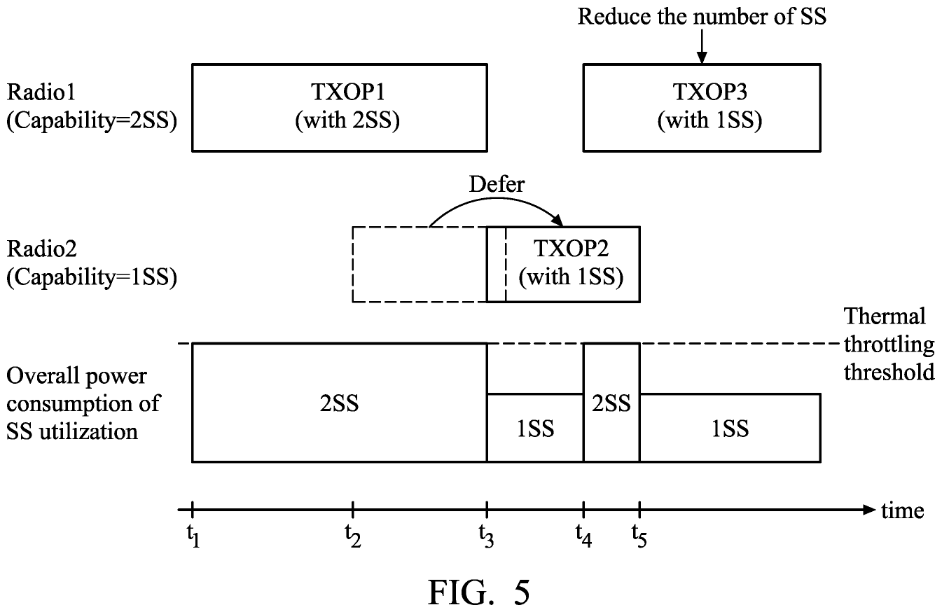

FIG. 5 is a schematic diagram illustrating the enhanced thermal throttling design for a multi-radio transmitter according to an embodiment of the application.

In this embodiment, the transmitter includes two radio transceivers, wherein the first radio transceiver supports 2 SS (i.e., the maximum number of MIMO layers supported by the first radio transceiver) and the second radio transceiver supports 1 SS (i.e., the maximum number of MIMO layers supported by the second radio transceiver).

To begin with, a Tx opportunity (denoted as TXOP1 in FIG. 5) for the first radio transceiver (denoted as Radio1 in FIG. 5) starts from time t₁ to time t₃. In particularly, the number of SS utilized in TXOP1 is 2. Specifically, TXOP1 refers to a time duration for which the first radio transceiver is allowed to perform wireless transmission after it has won contention for the radio channel.

Next, a Tx opportunity (denoted as TXOP2 in FIG. 5) for the second radio transceiver (denoted as Radio2 in FIG. 5) is scheduled at time t₂ during TXOP1. In particularly, the number of SS to be utilized in TXOP2 is 1. Specifically, TXOP2 refers to a time duration for which the second radio transceiver is allowed to perform wireless transmission after it has won contention for the radio channel.

However, it is noted that if TXOP2 is really used by the second radio transceiver simultaneously with TXOP1 being used by the first radio transceiver, the power consumption of SS utilization in TXOP1 and TXOP2 (i.e., 3SS in total) will exceed the thermal throttling threshold in the time interval from t₂ to t₃. In other words, with the ongoing TXOP1, there is no sufficient power headroom that can suffice the power consumption of utilizing even only one SS in TXOP2. That is, before TXOP2 starts, the transmitter may need to determine the power headroom below the thermal throttling threshold, and make sure if the power headroom is enough for the SS utilization in TXOP2.

In response to the determination of the power consumption of SS utilization in TXOP1 and TXOP2 exceeding the thermal throttling threshold, the transmitter defers TXOP2 until TXOP1 ends.

Later, another Tx opportunity (denoted as TXOP3 in FIG. 5) for the first radio transceiver (denoted as Radio1 in FIG. 5) is scheduled at time t₄ during the deferred TXOP2. In particularly, the number of SS utilized in TXOP3 is 2.

However, it is noted that if TXOP3 is really used by the first radio transceiver simultaneously with TXOP2 being used by the second radio transceiver, the power consumption of SS utilization in TXOP2 and TXOP3 (i.e., 3SS in total) will exceed the thermal throttling threshold in the time interval from t₄ to t₅.

In response to the determination of the power consumption of SS utilization in TXOP2 and TXOP3 exceeding the thermal throttling threshold, the transmitter reduces the number of SS utilized in TXOP3. In another embodiment, the transmitter may reduce the power of the first radio transceiver, instead of reducing the number of SS.

Therefore, the overall power consumption of SS utilization in the multi-radio transmitter can be controlled under the thermal throttling threshold, and the problem of overheating of the transmitter can be solved.

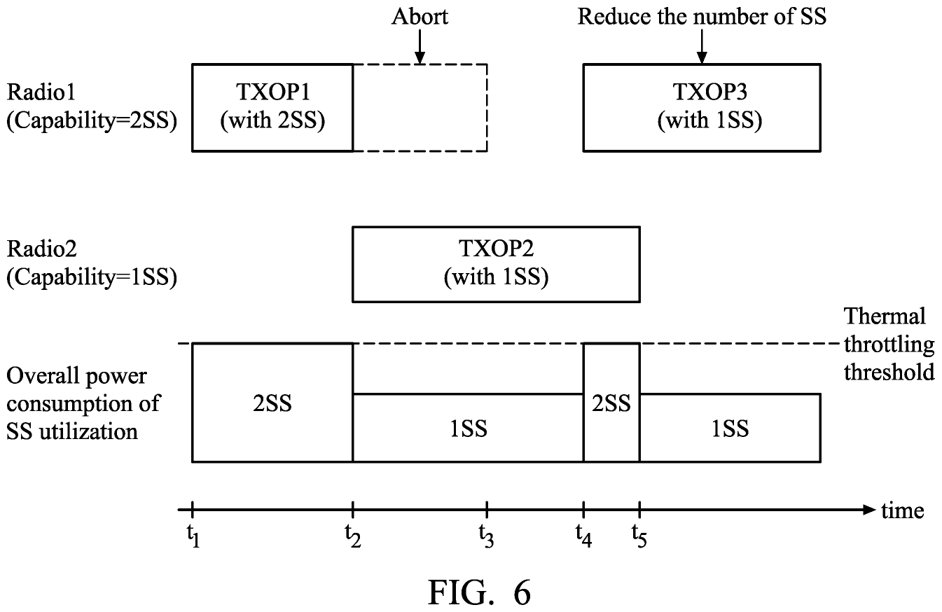

FIG. 6 is a schematic diagram illustrating the enhanced thermal throttling design for a multi-radio transmitter according to another embodiment of the application.

In this embodiment, the transmitter includes two radio transceivers, wherein the first radio transceiver supports 2 SS (i.e., the maximum number of MIMO layers supported by the first radio transceiver) and the second radio transceiver supports 1 SS (i.e., the maximum number of MIMO layers supported by the second radio transceiver).

To begin with, a Tx opportunity (denoted as TXOP1 in FIG. 6) for the first radio transceiver (denoted as Radio1 in FIG. 6) starts from time t₁ and is expected to end at time t₃. In particularly, the number of SS utilized in TXOP1 is 2.

Next, a Tx opportunity (denoted as TXOP2 in FIG. 6) for the second radio transceiver (denoted as Radio2 in FIG. 6) is scheduled at time t₂ during TXOP1. In particularly, the number of SS to be utilized in TXOP2 is 1.

However, it is noted that if TXOP2 is really used by the second radio transceiver simultaneously with TXOP1 being used by the first radio transceiver, the power consumption of SS utilization in TXOP1 and TXOP2 (i.e., 3SS in total) will exceed the thermal throttling threshold in the time interval from t₂ to t₃. In other words, with the ongoing TXOP1, there is no sufficient power headroom that can suffice the power consumption of utilizing even only one SS in TXOP2. That is, before TXOP2 starts, the transmitter may need to determine the power headroom below the thermal throttling threshold, and make sure if the power headroom is enough for the SS utilization in TXOP2.

In response to the determination of the power consumption of SS utilization in TXOP1 and TXOP2 exceeding the thermal throttling threshold, the transmitter aborts TXOP1 when TXOP2 starts.

In one example, the aborting of TXOP1 is performed in response to the data traffic in TXOP1 having a lower priority than the data traffic in TXOP2. For instance, the data traffic in TXOP1 may be associated with a call service or a video streaming service, and the data traffic in TXOP2 may be associated with an instant messaging service which may have a lower priority than the call service or video streaming service.

Later, another Tx opportunity (denoted as TXOP3 in FIG. 6) for the first radio transceiver (denoted as Radio1 in FIG. 6) is scheduled at time t₄ during TXOP2. In particularly, the number of SS utilized in TXOP3 is 2.

However, it is noted that if TXOP3 is really used by the first radio transceiver simultaneously with TXOP2 being used by the second radio transceiver, the power consumption of SS utilization in TXOP2 and TXOP3 (i.e., 3SS in total) will exceed the thermal throttling threshold in the time interval from t₄ to t₅.

In response to the determination of the power consumption of SS utilization in TXOP2 and TXOP3 exceeding the thermal throttling threshold, the transmitter reduces the number of SS utilized in TXOP3. In another embodiment, the transmitter may reduce the power of the first radio transceiver, instead of reducing the number of SS.

Therefore, the overall power consumption of SS utilization in the multi-radio transmitter can be controlled under the thermal throttling threshold, and the problem of overheating of the transmitter can be solved.

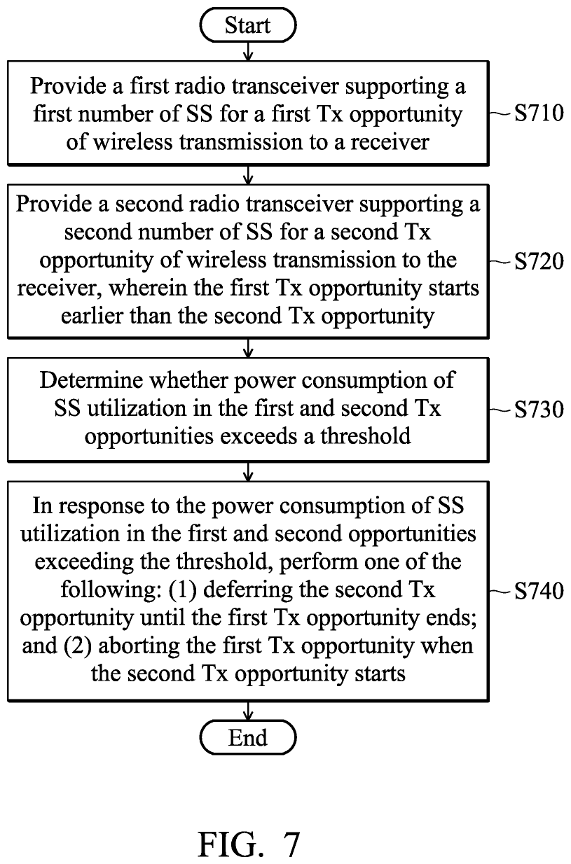

FIG. 7 is a flow chart illustrating the method of enhancements on the thermal throttling design for a multi-radio transmitter according to an embodiment of the application.

In step S710, a transmitter provides a first radio transceiver supporting a first number of SS for a first Tx opportunity of wireless transmission to a receiver.

In step S720, the transmitter provides a second radio transceiver supporting a second number of SS for a second Tx opportunity of wireless transmission to the receiver, wherein the first Tx opportunity starts earlier than the second Tx opportunity.

In step S730, the transmitter determines whether power consumption of SS utilization in the first and second Tx opportunities exceeds a threshold.

In step S740, the transmitter performs one of the following in response to the power consumption of SS utilization in the first and second opportunities exceeding the threshold: (1) deferring the second Tx opportunity until the first Tx opportunity ends; and (2) aborting the first Tx opportunity when the second Tx opportunity starts.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A transmitter, comprising:
a first radio transceiver, supporting a first number of Spatial Streams (SS) for a first Transmission (Tx) opportunity of wireless transmission to a receiver;
a second radio transceiver, supporting a second number of SS for a second Tx opportunity of wireless transmission to the receiver, wherein the first Tx opportunity starts earlier than the second Tx opportunity; and
a controller, configured to determine whether power consumption of SS utilization in the first and second Tx opportunities exceeds a threshold, and in response to the power consumption of SS utilization in the first and second opportunities exceeding the threshold, perform one of the following:
deferring the second Tx opportunity until the first Tx opportunity ends; and
aborting the first Tx opportunity when the second Tx opportunity starts.

2. The transmitter as claimed in claim 1, wherein the controller is further configured to reduce the first number of SS for the first Tx opportunity or the second number of SS for the second Tx opportunity, in response to the power consumption of SS utilization in the first and second opportunities exceeding the threshold.

3. The transmitter as claimed in claim 2, wherein the reduced first number of SS or the reduced second number of SS comprise at least one SS.

4. The transmitter as claimed in claim 1, wherein, before the second Tx opportunity starts, the controller is further configured to determine a power headroom below the threshold, and the deferring of the second Tx opportunity is performed in response to the power headroom not sufficing for a power consumption of utilizing only one SS in the second Tx opportunity.

5. The transmitter as claimed in claim 1, wherein the aborting of the first Tx opportunity is performed in response to data traffic in the first Tx opportunity having a lower priority than data traffic in the second Tx opportunity.

6. The transmitter as claimed in claim 1, wherein the threshold is configured for thermal throttling of the controller.

7. The transmitter as claimed in claim 1, wherein the transmitter is a Wireless-Fidelity (Wi-Fi) Station (STA) operating in a non-Access Point (AP) mode, and the receiver is a Wi-Fi AP.

8. The transmitter as claimed in claim 1, wherein the transmitter is a Wi-Fi STA operating in an AP mode, and the receiver is a Wi-Fi STA.

9. The transmitter as claimed in claim 1, wherein the transmitter is a Wi-Fi AP, and the receiver is a Wi-Fi STA.

10. The transmitter as claimed in claim 1, wherein the first Tx opportunity is a first time duration for which the first radio transceiver is allowed to perform wireless transmission, and the second Tx opportunity is a second time duration for which the second radio transceiver is allowed to perform wireless transmission.

11. A method, comprising:
providing, by a transmitter, a first radio transceiver supporting a first number of Spatial Streams (SS) for a first Transmission (Tx) opportunity of wireless transmission to a receiver;
providing, by the transmitter, a second radio transceiver supporting a second number of SS for a second Tx opportunity of wireless transmission to the receiver, wherein the first Tx opportunity starts earlier than the second Tx opportunity;
determining, by the transmitter, whether power consumption of SS utilization in the first and second Tx opportunities exceeds a threshold; and
in response to the power consumption of SS utilization in the first and second opportunities exceeding the threshold, performing, by the transmitter, one of the following:
deferring the second Tx opportunity until the first Tx opportunity ends; and
aborting the first Tx opportunity when the second Tx opportunity starts.

12. The method as claimed in claim 11, further comprising:
reducing, by the transmitter, the first number of SS for the first Tx opportunity or the second number of SS for the second Tx opportunity, in response to the power consumption of SS utilization in the first and second opportunities exceeding the threshold.

13. The method as claimed in claim 12, wherein the reduced first number of SS or the reduced second number of SS comprise at least one SS.

14. The method as claimed in claim 11, further comprising:
before the second Tx opportunity starts, determining, by the transmitter, a power headroom below the threshold;
wherein the deferring of the second Tx opportunity is performed in response to the power headroom not sufficing for a power consumption of utilizing only one SS in the second Tx opportunity.

15. The method as claimed in claim 11, wherein the aborting of the first Tx opportunity is performed in response to data traffic in the first Tx opportunity having a lower priority than data traffic in the second Tx opportunity.

16. The method as claimed in claim 11, wherein the threshold is configured for thermal throttling of a controller of the transmitter.

17. The method as claimed in claim 11, wherein the transmitter is a Wireless-Fidelity (Wi-Fi) Station (STA) operating in a non-Access Point (AP) mode, and the receiver is a Wi-Fi AP.

18. The method as claimed in claim 11, wherein the transmitter is a Wi-Fi STA operating in an AP mode, and the receiver is a Wi-Fi STA.

19. The method as claimed in claim 11, wherein the transmitter is a Wi-Fi AP, and the receiver is a Wi-Fi STA.

20. The method as claimed in claim 11, wherein the first Tx opportunity is a first time duration for which the first radio transceiver is allowed to perform wireless transmission, and the second Tx opportunity is a second time duration for which the second radio transceiver is allowed to perform wireless transmission.
